(19) United States
(12) Patent Application Publication
(10) Pub. No.: US 2005/0246486 A1
(43) Pub. Date: Nov. 3, 2005

(54) Method for dividing IDE HDD into multiple primary partitions

(76) Inventors: Min-Lung Chiu, Taipei (TW); Yun-Kuei Chiang, Taipei (TW); Mau-Ying Fu, Taipei (TW)

Correspondence Address: Han-Yi Lee;BAYSHORE PATENT GROUP, LLC., 520 Chantecler Dr., Fremont, CA, 94539, US

(21) Appl. No.: 10/965,110

(22) Filed: Oct. 14, 2004

(30) Foreign Application Priority Data
Apr. 28, 2004 (TW) 093111802

(51) Int. Cl. G06F 12/00

(52) U.S. Cl. 711/112; 711/173

(57) ABSTRACT

Disclosed is a method for dividing an IDE HDD into multiple primary partitions. A step (A) is to divide an IDE HDD into a first partition and a second partition. A step (B) is to divide the second partition into more than one primary partitions. A step (C) is to hide the second partition to prevent unauthorized access to the second partition.

### FIELD OF THE INVENTION

The invention relates to a method for dividing an HDD into partitions, particularly to one that is not easily damaged or limited to a fixed number of primary partitions.

### BACKGROUND OF THE INVENTION

The conventional measure for dividing an HDD into more than one partitions includes the PartitionMagic software available from PowerQuest Corporation, where the partitions are divided through which software all compatible with the IBM PC standards, such that the HDD after being subject to the division can still be operated under the conventional OS platforms, such as Microsoft Windows or Linux O/S. However, in order to be compatible with the IBM-compatible PC standards, the maximum number of primary partitions for accessing data, that an HDD can be divided into, is four. In addition, though the above PartitionMagic software is featured with the function of hiding partitions, data stored in the hidden partitions may still be damaged by certain programs, such as virus programs or low-level formatting programs. Thus, one of the major shortcomings for partitions that are divided through the conventional measures is that the data stored in the partitions cannot be safely guarded against damages.

In view of the above, this invention discloses a method for forming primary partitions, which is not easily damaged or limited to a fixed number of primary partitions but capable of coexisting in a HDD that is still compatible with the IBM-compatible PC standards.

### SUMMARY OF INVENTION

It is thus a primary objective of this invention to provide a method for forming primary partitions, which is not easily damaged or limited to a fixed number of primary partitions but capable of coexisting in a HDD that is still compatible with the current partition standards.

To achieve the above objective, this invention provides a method for dividing an IDE HDD into multiple primary partitions, comprising the steps of: dividing an IDE HDD into a first partition and a second partition; dividing the second partition into more than one primary partitions; and hiding the second partition to prevent unauthorized access to the second partition.

### BRIEF DESCRIPTION OF THE DRAWINGS

These and other modifications and advantages will become even more apparent from the following detailed description of a preferred embodiment of the invention and from the drawings in which:

FIG. 1 is a schematic drawing reflecting the arrangement in an HDD formed by the method according to this invention;

FIG. 2 is a flowchart illustrating the method of this invention; and

FIG. 3 is a flowchart illustrating the booting process of a basic I/O system (BIOS) adapted to the method of this invention.

### DETAILED DESCRIPTION OF THE INVENTION

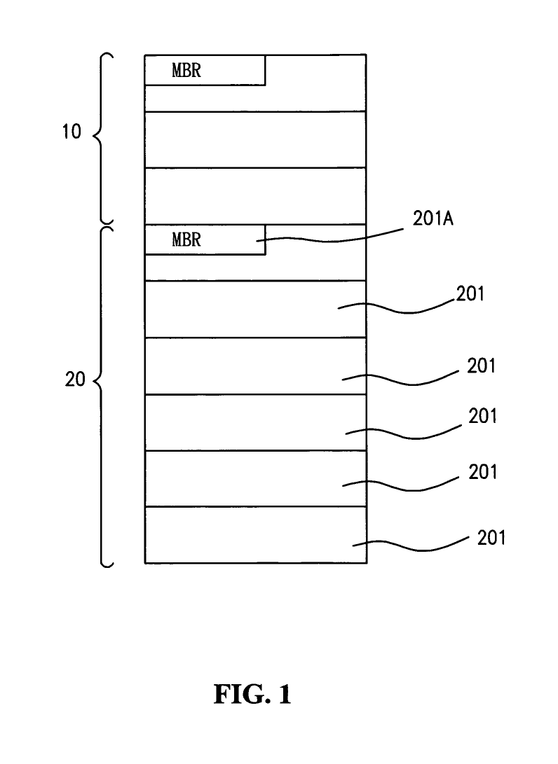

This invention discloses a method for dividing an IDE HDD into multiple primary partitions 30, as shown in the schematic drawing reflecting the arrangement in an HDD formed by the method according to this invention in FIG. 1. The primary function of the method is to divide an IDE HDD into two regions 10, 20. The first region 10 may be divided into partitions that would comply with the present partition standards, such as one that is fully compatible with the IBM-compatible PC standards to be employed by the presently available O/S, such as Microsoft Windows or Linux O/S and accurately accessed by software developed over such platforms. To facilitate explanations of this invention, the first region 10 in the preferred embodiment is one that is fully compatible with the IBM-compatible PC standards, while the second regions 20 as divided is one that is completely incompatible with the IBM-compatible PC standards such that they cannot be accessed by the above described platforms. According to the needs in actual applications, the method 30 of this invention may employ a specific process for dividing the second region 20 into an unlimited number of primary partitions 201, so as to overcome the shortcomings found in the conventional method for dividing an IDE HDD into partitions that are fully compatible with the IBM-compatible PC standards.

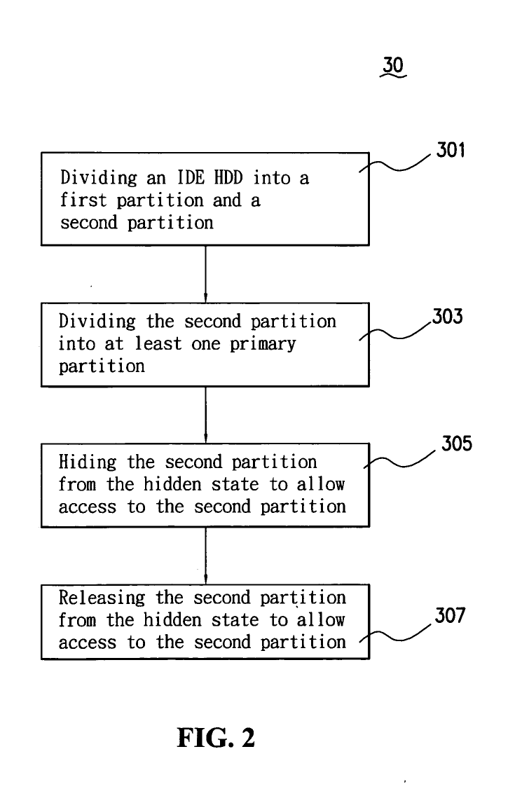

FIG. 2 is a flowchart illustrating the method of this invention. The method 30 of this invention includes three steps 301, 303 and 305. In Step 301, an IDE HDD is first divided into a first partition 10 and a second partition 20, wherein the first partition 10 may be one resulted from the conventional method, such as performing the FDISK command available from the DOS O/S or the above described PartitionMagic software.

In Step 303, the second partition 20 is then divided into at least one primary partition 201. To carry out this Step, the technique of Master Boot Record (MBR) may be implemented to store the master boot record 201A employed by the second partition 20 in a predetermined space of the second partition 20, wherein the master boot record 201A is primarily provided to define the primary partition 201, such as the initial and end locations of the primary partition 201. Because the master boot record 201A is incompatible with the conventional dividing method for IBM-compatible PC standards, the primary partitions 201A of the second partition 20 are inaccessible to the applications in the conventional O/S.

In Step 305 of this invention, the second partition is hidden to prevent unauthorized access to the second partition 20. Though the primary partitions 201A of the second partition 20 are inaccessible to the applications in the conventional O/S under normal execution, the second partition 20 is hidden to guard security of the second partition 20 according to this invention. The built-in command SetMax of AT Attachment may be employed to carry out Step 305. The execution of the SetMax command can limit the access to the IDE HDD to the first partition 10 only so as to prevent unauthorized access to the second partition 20.

By carrying out Steps 301 to 305 of the method 30 of this invention, the second partition 20 of the IDE HDD may be completely and securely protected. Because the second partition 20 may serve to provide various applications, such as loading applications for recovering the computer system, applications relevant to embedded system or multi-media playback system into each of the primary partitions 201 of the second partition 20, the applications loaded in the conventional O/S or one of applications loaded in the second partition 20 may be launched in accordance with the item as selected upon turning on the computer.

To carry out the various applications loaded in the second partition 20, the method 30 of this invention further includes Step 307. In Step 307, the second partition 20 is released from the hidden state to allow access to the second partition 20. The built-in command SetMax of AT Attachment may be employed to carry out Step 307. The execution of the SetMax command can cancel the limitations imposed to the IDE HDD to the second partition 20 so as to allow access to the applications loaded in the second partition 20.

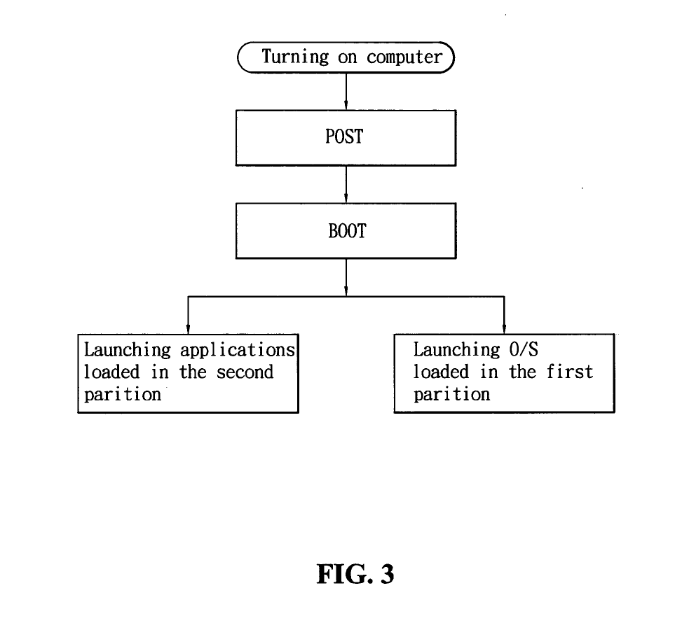

FIG. 3 is a flowchart illustrating the booting process of a basic I/O system (BIOS) adapted to the method of this invention. After the BIOS completes the POST verification upon turning on the computer, the computer is subject to the BOOT process. The system loaded by the BOOT process may be the conventional O/S platform loaded in the first partition 10, or any of the applications loaded in the second partition 20. The means for determining which of the regions 10, 20 is to be launched may, for example, be based on whether the user presses a determined key that indicates a request for launching the applications loaded in the second partition 20. The BIOS would determine which system or application is to be launched based on whether the predetermined key has been pressed.

Further, the BIOS adapted to the method of this invention may further be built-in with a Loader, which is primarily provided to allow access to the master boot record in the first partition 10 as well as the master boot record 201A of the second partition 20. In accordance with the data as obtained upon accessing the master boot record 201A, the Loader may have a complete comprehension of the arrangement of primary partitions 201 in the second partition 20.

This invention is related to a novel creation that makes a breakthrough in the art. Aforementioned explanations, however, are directed to the description of preferred embodiments according to this invention. Since this invention is not limited to the specific details described in connection with the preferred embodiments, changes and implementations to certain features of the preferred embodiments without altering the overall basic function of the invention are contemplated within the scope of the appended claims.

1. A method for dividing an IDE HDD into multiple primary partitions, comprising the steps of:
(A) dividing an IDE HDD into a first partition and a second partition;
(B) dividing said second partition into more than one primary partitions; and
(C) hiding said second partition to prevent unauthorized access to said second partition.

2. The method of claim 1, wherein said hiding step of said Step (C) comprising: employing a built-in command SetMax of AT Attachment to designate said second partition to be hidden.

3. The method of claim 1, further comprising the step of:
(D) releasing the limitations imposed to said hidden second partition so as to allow authorized access to said second partition.

4. The method of claim 3, wherein said releasing step of said Step (D) comprising: employing a built-in command SetMax of AT Attachment to designate said second partition to be cancelled from the hidden state.

5. The method of claim 1, wherein said second partition comprises at least one master boot record for defining each of said primary partitions of said Step (B).

6. The method of claim 5, wherein said master boot record is accessed by a Loader.

7. The method of claim 6, wherein said Loader is built in a BIOS.

8. The method of claim 1, wherein said first partition includes a master boot record that is compatible with IBM-compatible PC standards and serves to define the each of said partitions located in the first partition in said Step (A).
